(19) United States
(12) Patent Application Publication
(10) Pub. No.: US 2026/0120030 A1
(43) Pub. Date: Apr. 30, 2026

(54) AI-DRIVEN, DYNAMIC, TASK-BASED INFORMATION RETRIEVAL AND PROCESSING SYSTEM

(71) Applicant: Auquan Ltd., London (GB)

(72) Inventors: Chandini Jain, New York, NY (US); Shubham Jain, Bengaluru (IN)

(21) Appl. No.: 19/363,305

(22) Filed: Oct. 20, 2025

Related U.S. Application Data
(60) Provisional application No. 63/711,323, filed on Oct. 24, 2024.

(51) Int. Cl. G06Q 10/0633; G06F 16/2453; G06Q 30/0203; G06Q 40/06

(52) U.S. Cl. CPC G06Q 10/06334; G06F 16/24535; G06Q 30/0203; G06Q 40/062

(57) ABSTRACT

The disclosed invention presents an AI-driven, dynamic, task-based information retrieval and processing system tailored for the financial sector. Utilizing advanced machine learning, natural language processing, and data analytics, this system automates the decomposition of complex tasks into manageable sub-tasks, executes these through a sophisticated data processing pipeline, and generates customized reports. The system enhances efficiency by integrating knowledge graphs for query augmentation, employing noise filtering algorithms, and adaptively re-ranking documents to align with user-specific contexts and objectives. This approach addresses the challenges of manual data synthesis and the inflexibility of existing semi-automated systems, significantly reducing the time and labor involved in generating precise and relevant financial reports. By streamlining the retrieval and processing of vast and varied financial data, the system supports informed decision-making and reduces operational costs, making it a valuable tool for financial analysts and investment professionals.

### RELATED APPLICATIONS

This application claims the benefit of priority under 35 U.S. C. § 119(e) to U.S. Provisional Ser. No. 63/711,323 , filed Oct. 24, 2024, titled “AI-DRIVEN, DYNAMIC, TASK-BASED INFORMATION RETRIEVAL AND PROCESSING SYSTEM,” which is hereby incorporated by reference in its entirety.

### TECHNICAL FIELD

The present invention relates to the field of artificial intelligence (AI) and data processing. More specifically, it pertains to an AI-driven system designed to automate and optimize the retrieval, processing, and generation of information based on user-defined tasks and workflows. This system leverages advanced techniques in machine learning, natural language processing, and data analytics to dynamically decompose complex tasks into manageable sub-tasks, execute these tasks through a data processing pipeline, and generate customized reports or outputs that align with specific user requirements and objectives.

### BACKGROUND

In the realm of investing and financial decision-making, the reliance on data-driven strategies is paramount. Financial analysts, investors, and other stakeholders in the financial sector depend heavily on accurate, timely, and comprehensive data to make informed decisions. This data includes information related to financial markets, which generate vast amounts of data daily, sourced from a myriad of channels including stock exchanges, financial news outlets, company reports, economic indicators, court rulings, and regulatory updates. The nature of this data makes it time-consuming and labor-intensive to synthesize meaningful outputs. This is in part because there are many different data sources, each accessible through separate interfaces, requiring separate tools and authentication information. Consequently, decision-makers must sift through extensive datasets to find relevant information. In fact, because of this complexity, analysts often specialize in one type of data or one type of report, increasing overall costs due to the need to employ several data analysts with specialized expertise.

### BRIEF DESCRIPTION OF THE DRAWINGS

Embodiments of the present invention are illustrated by way of example and not limitation in the figures of the accompanying drawings, in which:

FIG. 1 is a diagram illustrating an example of a conventional data retrieval and processing technique, used by an analyst in accessing data and generating work product, such as a report.

FIG. 2 is a diagram illustrating an improved AI-driven, task-based, data retrieval and processing system, for generating output (e.g., reports), consistent with some examples.

FIG. 3 is a diagram illustrating an example of a user interface for an AI-driven, task-based, data retrieval and processing system, consistent with some examples.

FIG. 4 is a diagram illustrating an example of a data processing pipeline performing a series of operations to execute a workflow, associated with a selected task, to generate an output, according to some examples.

FIG. 5 is an example of an output (report) generated by an embodiment of the task-based, data retrieval and processing system, as described herein.

FIG. 6 is a block diagram illustrating a software architecture, which can be installed on any of a variety of computing devices to perform methods consistent with those described herein.

FIG. 7 illustrates a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are techniques for generating an output using a task-based workflow system that involves the processing of multiple queries in a Retrieval-Augmented Generation (RAG) framework, and the synthesizing of information by one or more generative language models (e.g., large language models, or LLMs). Specifically, embodiments of the invention include methods and systems for decomposing complex tasks into a series of structured queries and sub-queries, each enhanced through the integration of knowledge graphs and tailored query augmentation. The system further refines the retrieval of information by employing advanced noise filtering algorithms and adaptively re-ranking documents to align with the specific context and objectives of the user. This description sets forth numerous specific details and innovative features to provide a comprehensive understanding of the embodiments of the present invention. It will be apparent to those skilled in the art that the present invention may be practiced and implemented in various forms and that the invention can be adapted and modified without departing from its scope as outlined in the following detailed description.

In the realm of investing and financial decision-making, reliance on data-driven strategies is essential. Financial analysts, investors, and other stakeholders in the financial sector depend heavily on accurate, timely, and comprehensive data to make informed decisions. The financial markets generate vast amounts of data daily, sourced from a myriad of channels including stock exchanges, financial news outlets, company reports, economic indicators, court rulings, and regulatory updates. This data is necessary for tracking market trends, assessing financial health, understanding the legal landscape, assessing various risks, and predicting future market behaviors. The sheer volume and variety of data available can pose significant challenges, as decision-makers sift through extensive datasets to find relevant information for specific needs and decisions.

Current solutions for data retrieval and processing in the financial sector often involve manual efforts or semi-automated systems that lack the sophistication to handle complex, multi-faceted tasks efficiently. These systems typically rely on static queries and predefined workflows that are performed manually, which can be inflexible and unable to adapt to the dynamic nature of financial data. Additionally, existing systems may not effectively filter out irrelevant information, leading to noise and inefficiencies in the input data, and thus, included in the output. The lack of customization in report generation further limits the utility of these systems, as they may not align with the specific requirements and preferences of different users or organizations.

Moreover, it can be both time-consuming and labor-intensive to obtain and manually synthesize information, as the required data is distributed amongst a variety of different data sources, each having its own unique challenges to obtain. For instance, financial data may be spread across stock exchanges, financial news outlets, company reports, economic indicators, court rulings, and regulatory updates. Each of these different data sources often requires separate tools, interfaces, and authentication information, adding layers of complexity to the data retrieval process. Analysts must navigate through these disparate systems, manually extract relevant data, and then synthesize it into a coherent format. This fragmented approach not only increases the time and effort required but also heightens the risk of missing critical information or introducing errors. Consequently, the need for specialized analysts who focus on specific types of data or reports further escalates operational costs, making the entire process less efficient and more resource-intensive.

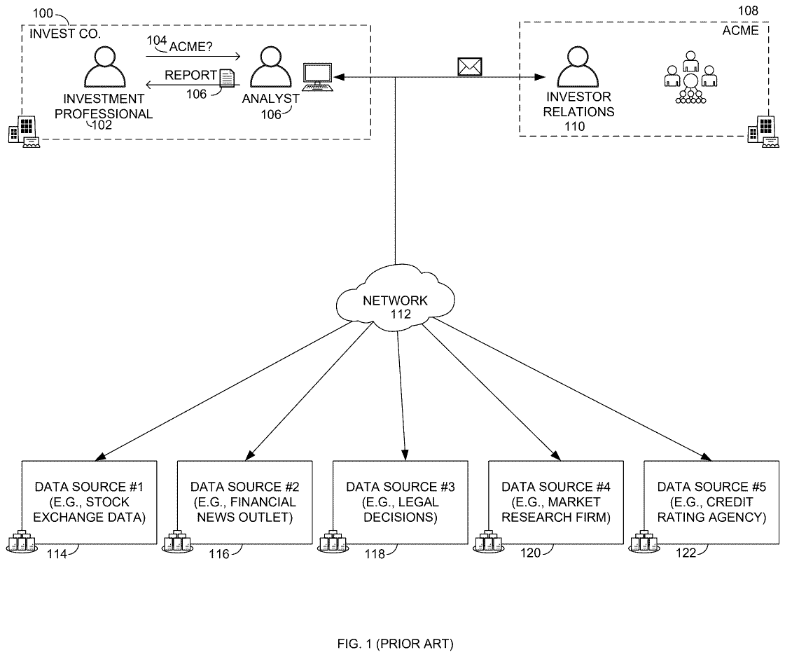

FIG. 1 illustrates an example of a conventional technique for gathering information from a variety of disparate data sources and processing the data to generate a report on a company, ACME. In this conventional approach, an analyst 106 typically follows a multi-step, manual process to compile and analyze the necessary information. As shown in FIG. 1, an investment professional 102 at an investment company 100 may first identify a need to generate a report on a particular company, ACME 108. The investment professional 102 communicates this requirement 104 to an analyst 106. The analyst 106 may initially reach out to a member of the investor relations team 110 at the target company, and then manually searches for relevant data across multiple data sources, which may include data source #1 (e.g., stock exchange data 114), data source #2 (e.g., financial news outlet 116), data source #3 (e.g., legal decisions 118), data source 4 (e.g., market research firm 120), and data source 5 (e.g., credit rating agency 122). These sources are often disparate and unconnected, requiring the analyst 106 to access each one individually through a computer network 112—sometimes using different client-based tools and almost always using different authentication credentials (e.g., username/password). These data sources are also conveyed here to illustrate by way of example the sheer number of data sources from which data can be obtained, and the diversity of the data types.

Once the data is collected, the analyst 106 manually filters through the information to identify relevant data points. This step involves sifting through large volumes of data to extract pertinent details about ACME's financial health, market trends, legal landscape, and other relevant factors. The manual nature of this process can lead to inefficiencies and the potential for overlooking information.

After filtering the data, the analyst 106 processes the information to generate insights. This step may involve using various analytical tools and techniques to interpret the data, identify patterns, and draw conclusions. For example, performance data for a company may be analyzed using spreadsheets. The analyst 106 then manually compiles these insights into a coherent report format. This report typically includes sections on ACME's financial performance, market position, competitive landscape, and any relevant legal or regulatory issues.

The final report is then reviewed and refined to ensure accuracy and completeness. This step may involve cross-referencing the data with additional sources, verifying the information, and making any necessary adjustments. Once the report is finalized, the report is communicated to one or more investment professionals 102 to inform decision-making.

Overall, FIG. 1 highlights the labor-intensive and time-consuming nature of a conventional technique for gathering and processing information to generate a report on a company. The reliance on manual efforts and the lack of integration between disparate data sources may lead to inefficiencies and potential inaccuracies in the final report. The approach illustrated in FIG. 1 is provided as just one example, and in actual practice, any given firm may employ an entire team of analysts who may focus on different reporting needs for any number of companies within different sectors of different industries, and so forth. Furthermore, there are many different types of reports that may be generated, to include, as an example, industry reports, company reports, reports that are generated in support of possible future investments, as well as reports relating to current investments. This further complicates the process, as each analyst may specialize in a particular type of data or report, necessitating coordination and collaboration among team members to compile comprehensive reports. This specialization can increase overall costs and introduce additional layers of complexity, making the entire process less efficient and more prone to errors.

The systems and techniques described herein address these challenges by introducing an AI-driven, dynamic, task-based information retrieval and processing system. This system automates and optimizes the retrieval, processing, and generation of information based on user-defined tasks and workflows. Leveraging advanced techniques in machine learning, natural language processing, and data analytics, the system dynamically decomposes complex tasks into manageable sub-tasks, executes these tasks through a processing pipeline, and generates customized reports or outputs that align with specific user requirements and objectives. By augmenting user queries with domain-specific knowledge graphs, filtering out irrelevant information through noise reduction algorithms, and dynamically ranking documents based on user context and intent, the system enhances the performance and accuracy of data retrieval and processing in the financial sector.

Consistent with some examples, the task-based workflows are presented by the system in a role-based manner, ensuring that each end-user is presented with tasks relevant to their specific role. For example, an investment analyst may be presented with tasks related to generating market and competition reports, while a compliance officer may be tasked with identifying exposure to sanctions or legal risks. Each task is associated with a specific type and format of output, such as a detailed report or a summary document. These reports are conveyed electronically but can also be downloaded for printing. Depending on the role of the end-user and the selected task, the system may prompt the end-user to provide initial input parameters. These input parameters can include, for example, a company name, a date range, an industry, or a sector within an industry. For instance, an investment analyst might input the name of a company and a date range to generate a market analysis report, while a compliance officer might input a list of companies and a specific regulatory framework to identify potential compliance issues.

Once the initial inputs are provided, the system initiates a workflow, based on the selected task, to generate an output, which may be in the form of a report. This workflow involves processing one or more queries to gather and analyze relevant data. Each query is augmented or enhanced using domain-specific knowledge graphs to ensure comprehensive data retrieval. The system employs advanced noise filtering algorithms to eliminate irrelevant information and dynamically re-ranks documents based on the specific context and objectives of the user. For example, in generating a market analysis report, the system might process queries related to industry growth, competitor analysis, and market trends. The retrieved information is then synthesized using a generative language model (e.g., LLM) through iteratively submitting prompts. This iterative process ensures that the final output is comprehensive and tailored to the user's specific needs. The system can format the information to generate a particular output or report, such as a detailed market analysis or a compliance summary, thereby streamlining the data retrieval and processing workflow for financial analysts and other stakeholders. Other aspects and advantages of the various embodiments of the systems and techniques are set forth below in connection with the description of the several figures that follows.

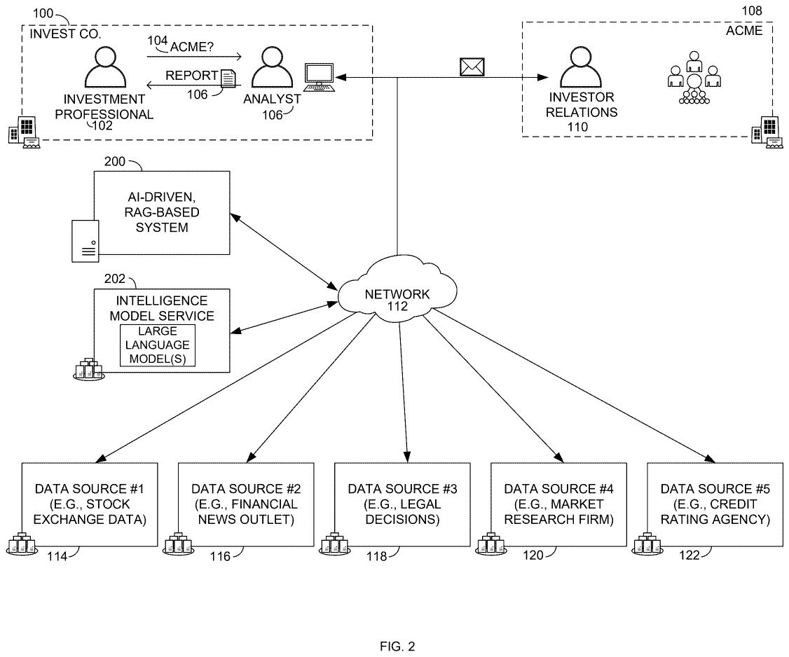

FIG. 2 illustrates an improved task-based, AI-driven, data retrieval and processing system 200 for generating customized reports. The system 200 comprises an AI-driven, RAG-based system 200, an intelligence model service 202, a network 112, and multiple data sources including, by way of example, data source #1 (e.g., stock exchange data 114), data source #2 (e.g., financial news outlet 116), data source #3 (e.g., legal decisions 118), data source #4 (e.g., market research firm 120), and data source #5 (e.g., credit rating agency 122). These data sources are provided as examples, and in actual practice, there may be many more and varied data sources not shown in FIG. 2.

An end-user, such as an analyst 106, utilizes a client computing device, which may include one or more client-based software applications (e.g., a web browser or proprietary software application) to access the system 200. The AI-driven, RAG-based system 200 connects to the network 112 to facilitate data retrieval and processing. The system 200 provides for the processing of a workflow, consisting of one or more complex tasks decomposed into manageable sub-tasks, executed via a processing pipeline to generate customized reports or outputs that align with specific user requirements and objectives. The system 200 leverages advanced techniques in machine learning, natural language processing, and data analytics.

The intelligence model service 202, which includes large language models, enhances the AI-driven, RAG-based system 200 by providing advanced natural language processing capabilities. The intelligence model service 202 augments user queries with domain-specific knowledge graphs, filters out irrelevant information through noise reduction algorithms, and dynamically ranks documents based on user context and intent.

An end-user, such as an analyst 106, utilizes a client computing device, which may include one or more client-based software applications (including, for example, a web browser or proprietary software application) to access the system 200. The system 200 interacts with an investment company 100, an investment professional 102, an analyst 106, and investor relations 110.

The intelligence model service 202 is a cloud-based provider of AI models, such as generative language models, including specifically what are known as Large Language Models (LLMs). LLMs are Transformer decoder-based models, some of which are known as Generative Pre-trained Transformers (GPTs). The service provides access to these models via an application programming interface (API). The system 200 may be integrated to use multiple models in parallel, where specific prompts associated with specific queries, associated with specific tasks, are routed to fine-tuned models best suited for the task at hand. Some models may be multi-modal, meaning they have vision capabilities and can process information beyond just text.

The intelligence model service 202, which includes large language models, enhances the AI-driven, RAG-based system 200 by providing advanced natural language processing capabilities. The intelligence model service 202 augments user queries with domain-specific knowledge graphs, filters out irrelevant information through noise reduction algorithms, and dynamically ranks documents based on user context and intent. This integration ensures that the system 200 can efficiently and accurately process complex tasks, providing end-users with high-quality, customized reports and outputs.

The network 112 facilitates communication between the AI-driven, RAG-based system 200, the intelligence model service 202, and the various data sources. The network 112 ensures seamless data transfer and integration, enabling the system 200 to access and process information from multiple sources efficiently.

Data source #1 114 provides stock exchange data, which includes information related to stock prices, trading volumes, and market trends. Data source #2 116 offers financial news, which includes updates on market developments, company announcements, and economic indicators. This information helps analysts stay informed about financial news and trends. Data source #3 118 supplies legal decisions, which include court rulings, regulatory updates, and legal precedents. This data is necessary for understanding the legal landscape and assessing potential legal risks. Data source #4 120 provides market research, which includes industry reports, competitor analysis, and market forecasts. This information helps analysts understand market dynamics and make informed investment decisions. Data source #5 122 offers credit ratings, which include assessments of companies'creditworthiness and financial stability. This data is important for evaluating credit risk and making investment decisions. It should be noted that these examples represent only a subset of the myriad data sources that may be available in actual practice, each contributing unique and valuable insights to enhance the comprehensiveness and accuracy of financial reporting and analysis.

The investment company 100 includes an investment professional 102 who identifies the need for a report and communicates this requirement to an analyst 106. The analyst 106 uses the AI-driven, RAG-based system 200 to gather and process data from the various data sources, generating a customized report.

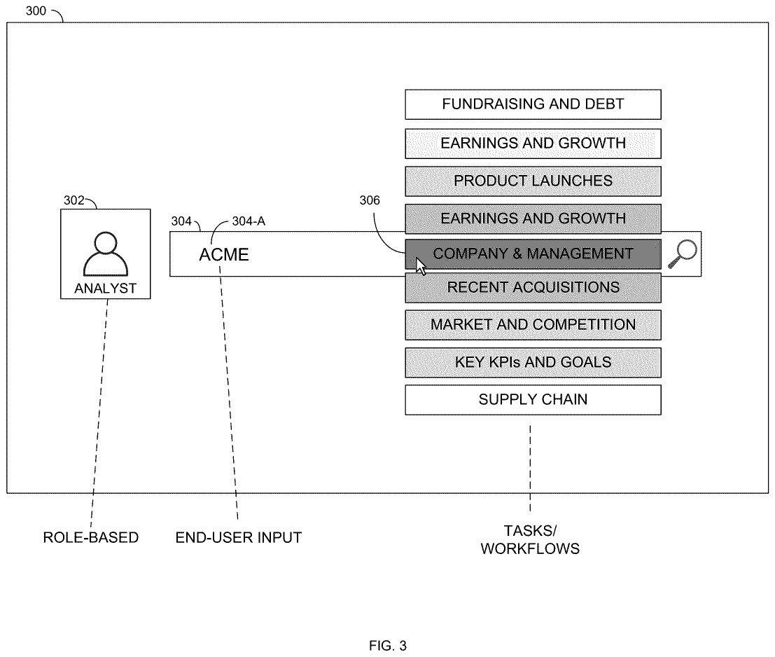

FIG. 3 shows an example user interface of the system 200. The user interface 300 is designed facilitate a service or system that is role-based, dynamically rendering tasks specific to the role of the end-user. An icon 302 represents the role of the end-user, in this case, an analyst. The user interface includes a text input box 304, where the analyst end-user has entered the name of a company, ACME 304-A.

The user interface 300 presents a list of tasks, each associated with an underlying workflow, such as “company & management” 306, with each task presented being relevant to the role of the analyst. Each task is also associated with a specific output—for example, a report. These tasks include “Fundraising and Debt,” “Earnings and Growth,” “Product Launches,” “Company & Management,” “Recent Acquisitions,” “Market and Competition,” “KPIs and Goals,” and “Supply Chain.” The tasks are selected for presentation to the end-user based on the role of the end-user as indicated by the icon 302.

The text input box 304 allows the end-user to specify the company of interest, in this case, ACME 304-A. However, in other instances, there may be a number of other intput items that can be specified or provided by the end-user, for example, such as date ranges, industries, people's names, countries, and so forth. The user interface may prompt the end-user for different user inputs, based on the selected task. The tasks are tailored to the specific needs and responsibilities of the analyst, ensuring that the information retrieval and processing are aligned with the end-user's role and objectives.

The user interface 300 facilitates efficient and targeted information retrieval by allowing the analyst to quickly access tasks and workflows that are pertinent to their role. The role-based design ensures that the tasks presented are relevant and useful, streamlining the process of data retrieval and report generation for the end-user, while simplifying the overall task-based processing by prompting only for specific inputs relevant to a selected task.

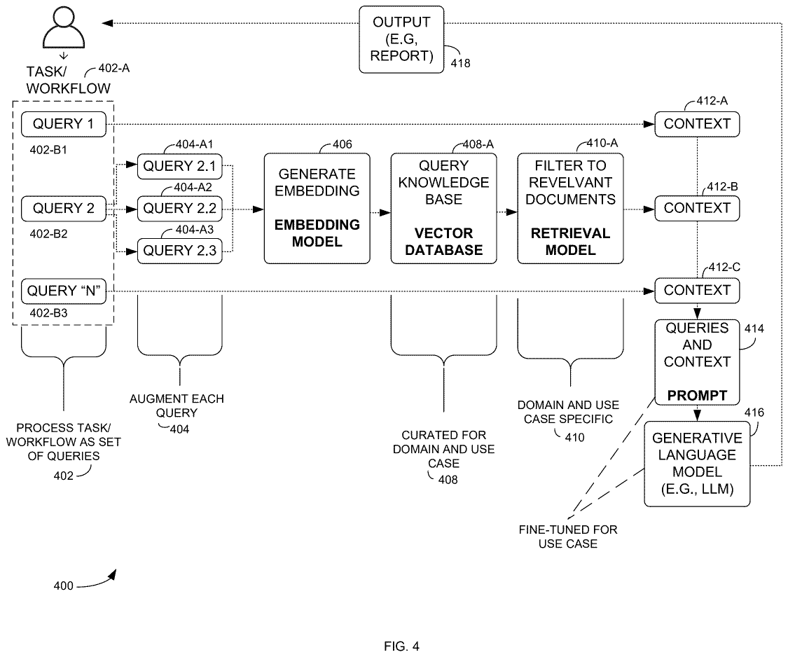

FIG. 4 shows a detailed illustration of the various processing steps involved in handling a workflow associated with a selected task. The workflow begins when an end-user selects a task 402-A. This task is associated with a workflow that typically involves one or several queries, each directed to retrieve data from different data sources. The processing of an individual query is described in greater detail in U.S. Provisional Application No. 63/566,177.

The workflow 400 is initiated by processing the task/workflow as a set of queries 402. This set includes multiple queries such as Query 1 402-B1, Query 2 402-B2, and Query “N” 402-B3. Each query undergoes augmentation 404, resulting in sub-queries such as Query 2.1 404-A1, Query 2.2 404-A2, and Query 2.3 404-A3. The augmentation process ensures that each query is enhanced for better data retrieval.

Once augmented, the queries proceed to the embedding generation step 406. Here, an embedding model generates embeddings for the queries, transforming them into a format suitable for further processing. The generated embeddings are then directed to a query knowledge base 408, which is a vector database curated for the specific domain and use case. This database stores the embeddings of documents and facilitates efficient retrieval of relevant information.

The next step involves filtering the retrieved documents 410 using a retrieval model 410-A. This model filters the documents to ensure that only the most relevant information is selected. The filtered documents are then provided as context 412-A, 412-B, and 412-C as part of an LLM prompt that includes an instruction for generating output, based on the context. This set is prepared for submission to a generative language model 416, such as a large language model (LLM), which is fine-tuned for the specific use case.

In the described system, each prompt is individually crafted and provided as input to the LLM. This granular approach allows for precise control over the information being processed and the output generated by the LLM. The process is in some examples iterative. For instance, the output received from the LLM in response to an initial prompt can be analyzed and refined based on its relevance and accuracy. This refined output can then serve as enriched context or input for a subsequent prompt, enhancing the depth and quality of the analysis.

This iterative cycle of generating prompts, receiving outputs, refining these outputs, and using them as the basis for new prompts allows the system to progressively hone in on the most pertinent and accurate information. It effectively creates a feedback loop where each cycle of interaction builds upon the previous, leading to increasingly sophisticated insights and reports. This iterative prompting process not only maximizes the utility of the LLM but also adapts to evolving user needs and complex analytical tasks, ensuring that the final outputs are both comprehensive and precisely tailored to specific requirements.

Accordingly, consistent with some examples, the processing of an individual query involves several steps:
Query Augmentation (404): Each query is augmented to enhance its effectiveness in retrieving relevant data. This involves breaking down the original query into multiple sub-queries. For example, Query 2 is decomposed into sub-queries such as Query 2.1 404-A1, Query 2.2 404-A2, and Query 2.3 404-A3. The augmentation process ensures that the query covers various aspects of the information sought, thereby improving the comprehensiveness of the data retrieval.
Embedding Generation (406): Once the queries are augmented, they proceed to the embedding generation step. An embedding model generates embeddings for the queries, transforming them into a numerical format suitable for further processing. Embeddings are dense vector representations of the queries that capture their semantic meaning, enabling efficient comparison and retrieval of relevant information.
Query Knowledge Base (408): The generated embeddings are then directed to a query knowledge base, which is a vector database curated for the specific domain and use case. This database stores the embeddings and facilitates efficient retrieval of relevant information. The knowledge base is designed to handle large volumes of data and provide quick access to the most pertinent documents.
Document Filtering (410): The next step involves filtering the retrieved documents using a retrieval model. This model applies advanced noise filtering algorithms to eliminate irrelevant information and ensure that only the most relevant documents are selected. The filtering process is crucial for reducing noise and improving the quality of the retrieved data.
Context Formation (412) The filtered documents, along with their context, are then used to form a comprehensive set of queries and context. This set includes the filtered documents and additional contextual information (412-A, 412-B, and 412-C) that provides a deeper understanding of the retrieved data. The context formation step ensures that the generative language model has all the necessary information to generate accurate and relevant outputs.
Generative Language Model (416): The comprehensive set of queries and context is submitted to a generative language model, such as a large language model (LLM). The LLM processes the queries and context to generate the final output. The model is fine-tuned for the specific use case, ensuring that the generated output aligns with the user's requirements and objectives.
Output Generation (418): The generative language model produces the final output, which can be in the form of a report or any other required format. The output is then communicated back to the end-user, completing the workflow. The system ensures that the final output is comprehensive, accurate, and tailored to the user's specific needs.

Despite showing only a single LLM in FIG. 4, in various alternative embodiments, more than one LLM may be used, with each LLM fine-tuned to handle a specific requirement or task. For instance, one LLM may be optimized for financial data analysis, another for legal document interpretation, and yet another for market trend forecasting. This modular approach allows the system to leverage the strengths of specialized models, ensuring that each query is processed by the most suitable LLM. When a query is decomposed into sub-queries, each sub-query can be routed to the appropriate LLM based on its specific requirements. This not only enhances the accuracy and relevance of the generated outputs but also improves the system's overall efficiency by utilizing domain-specific expertise embedded within each LLM. The integration of multiple LLMs ensures that the system can handle a wide range of tasks with high precision, providing end-users with tailored and contextually relevant information.

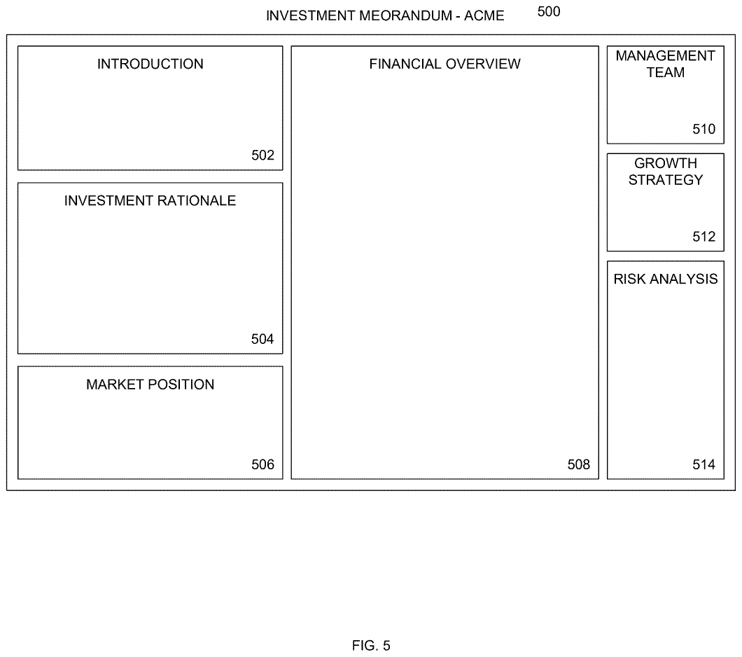

FIG. 5 illustrates an example report generated by the system consistent wish some embodiments. In this example, the report is titled, “Invesment Memorandum—ACME” 500. The report consists of seven separate sections, including “Introduction” 502, “Invesment Rationale” 504, “Market Position” 506, “Financial Overview” 508, “Management Team” 510, “Growth Strategy” 512, and “Risk Analysis” 514. Each section may be synthesized by the LLM, through the processing of one or more prompts, with information obtained through the processing of one or more queries.

In the system described, the generation of a comprehensive report such as the “Investment Memorandum—ACME” involves a structured and iterative process utilizing a Large Language Model (LLM) to synthesize each of the report's sections. Here's a detailed explanation of how this process would work for each section of the report:

The process begins with the generation of the “Introduction” section. A prompt specifically designed to elicit introductory content about ACME is formulated and provided to the LLM. This prompt might include queries that retrieve general information about ACME, such as its history, core business activities, and market significance. The LLM processes this prompt, leveraging data retrieved from relevant data sources, and synthesizes an introductory section that sets the stage for the detailed analysis that follows.

For the “Investment Rationale” section, a new prompt is created that focuses on why ACME represents a valuable investment opportunity. This prompt directs the LLM to process information related to ACME's competitive advantages, unique selling propositions, and potential for growth. The LLM integrates this information to articulate compelling reasons that justify an investment in ACME, drawing on data such as market trends, previous investment outcomes, and strategic positioning.

The “Market Position” section is synthesized by querying the LLM with prompts related to ACME's standing in the industry. This involves retrieving and processing data on market share, competitive landscape, and industry benchmarks. The LLM evaluates this information to provide a detailed overview of ACME's market position, highlighting strengths and areas of dominance within the industry.

To create the “Financial Overview” section, prompts are designed to extract detailed financial data. These prompts might involve complex queries that fetch financial statements, revenue models, profitability analysis, and financial projections. The LLM processes these inputs to generate a comprehensive financial summary that provides insights into ACME's financial health and economic viability.

The “Management Team” section is generated by prompts that gather information about the key personnel at ACME. This includes their professional backgrounds, roles within the company, and contributions to ACME's success. The LLM uses this information to construct profiles that highlight the expertise and leadership driving the company forward.

For the “Growth Strategy” section, the LLM is prompted to analyze and synthesize information regarding ACME's plans for expansion and development. This includes strategic initiatives, market expansion plans, product development, and innovation strategies. The LLM integrates this data to outline how ACME intends to achieve sustained growth and scalability.

Finally, the “Risk Analysis” section is crafted by prompting the LLM to identify and evaluate potential risks associated with investing in ACME. This involves processing data on market risks, regulatory challenges, competitive threats, and operational vulnerabilities. The LLM assesses these factors to provide a balanced view of the risks and mitigations that investors should consider.

Throughout this process, each section generated by the LLM can be reviewed and refined iteratively. Outputs from the LLM can be further processed, refined, and then re-inputted as context for subsequent prompts, enhancing the depth and accuracy of the report. This iterative cycle ensures that the final investment memorandum is not only comprehensive but also precisely tailored to reflect the most current and relevant information about ACME.

### Machine and Software Architecture

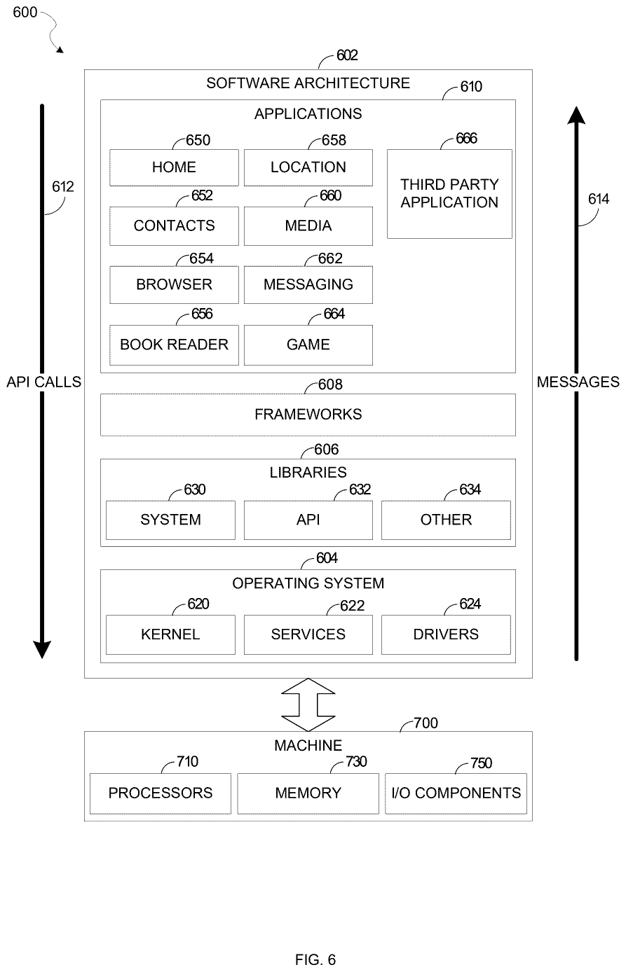

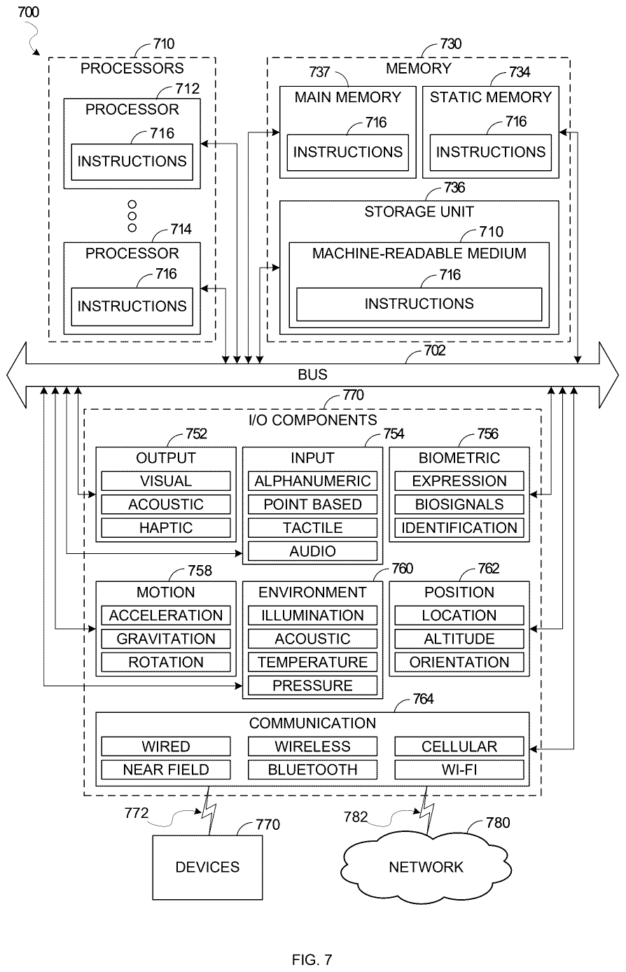

FIG. 6 is a block diagram 600 illustrating a software architecture 602, which can be installed on any of a variety of computing devices to perform methods consistent with those described herein. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 410 invoke API calls 412 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various GUI functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 600 in the form of a computer system within which a set of instructions may be executed for causing the machine to perform any one or more of the methodologies discussed herein, according to an example embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions 716 may cause the machine 700 to execute any one of the methods or algorithmic techniques described herein. Additionally, or alternatively, the instructions 716 may implement any one of the systems described herein. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 616 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory 730 may include a main memory 732, a static memory 734, and a storage unit 736, all accessible to the processors 710 such as via the bus 702. The main memory 730, the static memory 734, and storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### EXECUTABLE INSTRUCTIONS AND MACHINE STORAGE MEDIUM

The various memories (i.e., 730, 732, 734, and/or memory of the processor(s) 710) and/or storage unit 736 may store one or more sets of instructions and data structures (e.g., software) embodying or utilized by any one or more of the methodologies or functions described herein. These instructions (e.g., the instructions 716), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” are intended to mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method for generating customized reports using task-based processing, the method comprising:
receiving a user selection of a predefined task associated with a report generation workflow, wherein the task is decomposed into a plurality of information retrieval queries;
processing each query through an augmented retrieval system that enhances queries using domain knowledge, retrieves relevant information from data sources, and filters the information based on contextual relevance;
generating query-specific outputs by providing the filtered information as context to one or more generative language models;
synthesizing the query-specific outputs through iterative processing with the one or more generative language models to create a comprehensive analysis; and
generating a structured report based on the comprehensive analysis, wherein the report has a format that corresponds to the selected task.

2. The computer-implemented method of claim 1, wherein receiving the user selection comprises:
presenting predefined tasks through a role-based user interface that displays only tasks relevant to an organizational role of a user; and
receiving input parameters specific to the selected task, wherein the input parameters include at least one of a company name, date range, industry sector, or geographical region;
wherein the predefined tasks include investment analysis workflows, compliance assessment workflows, and market research workflows.

3. The computer-implemented method of claim 1, wherein processing each query through the augmented retrieval system comprises:
accessing a domain-specific knowledge graph containing financial entities, regulatory frameworks, and industry relationships;
expanding each query by incorporating related entities and semantic relationships from the domain-specific knowledge graph to generate enhanced sub-queries;
generating vector embeddings for the enhanced sub-queries using a trained embedding model; and
querying a vector database with the generated embeddings to retrieve candidate documents.

4. The computer-implemented method of claim 1, wherein filtering the information based on contextual relevance comprises:
applying noise filtering algorithms to eliminate documents that do not meet relevance thresholds;
dynamically re-ranking retrieved documents using a retrieval model that considers user objectives and query context; and
selecting a subset of highest-ranked documents to provide as context for the one or more generative language models.

5. The computer-implemented method of claim 1, wherein generating query-specific outputs comprises:
providing the filtered information as context within structured prompts to one or more large language models; and
receiving individual query responses from the large language models for each of the plurality of queries;
wherein different queries are routed to different specialized generative language models based on domain-specific expertise required for each query.

6. The computer-implemented method of claim 1, wherein synthesizing the query-specific outputs through iterative processing comprises:
combining the query-specific outputs into an intermediate comprehensive analysis;
submitting the intermediate analysis to the one or more generative language models with instructions to identify information gaps;
generating additional follow-up queries based on identified gaps;
processing the follow-up queries through the augmented retrieval system; and
repeating the iterative process until predetermined completeness criteria are satisfied.

7. The computer-implemented method of claim 1, wherein generating the structured report comprises:
formatting the comprehensive analysis according to a predetermined template associated with the selected task;
generating multiple report sections including an introduction, analysis content, and conclusions;
incorporating visual elements including charts and graphs generated by multi-modal artificial intelligence models; and
presenting the structured report through a user interface that allows for export in multiple document formats.

8. The computer-implemented method of claim 1, further comprising:
receiving one or more example documents from the user that represent a desired output format;
analyzing the example documents using the one or more generative language models to identify required report sections and content types;
generating supplemental queries based on the analysis of the example documents;
processing the supplemental queries through the augmented retrieval system to gather additional information; and
comparing the generated structured report with the example documents to ensure format and content alignment.

9. A system for generating customized reports using task-based processing, the system comprising:
one or more processors; and
one or more memory storage devices storing instructions thereon, which, when executed by the one or more processors, cause the system to perform operations comprising:
receiving a user selection of a predefined task associated with a report generation workflow, wherein the task is decomposed into a plurality of information retrieval queries;
processing each query through an augmented retrieval system that enhances queries using domain knowledge, retrieves relevant information from data sources, and filters the information based on contextual relevance;
generating query-specific outputs by providing the filtered information as context to one or more generative language models;
synthesizing the query-specific outputs through iterative processing with the one or more generative language models to create a comprehensive analysis; and
generating a structured report based on the comprehensive analysis, wherein the report has a format that corresponds to the selected task.

10. The system of claim 9, wherein receiving the user selection comprises:
presenting predefined tasks through a role-based user interface that displays only tasks relevant to an organizational role of a user; and
receiving input parameters specific to the selected task, wherein the input parameters include at least one of a company name, date range, industry sector, or geographical region;
wherein the predefined tasks include investment analysis workflows, compliance assessment workflows, and market research workflows.

11. The system of claim 9, wherein processing each query through the augmented retrieval system comprises:
accessing a domain-specific knowledge graph containing financial entities, regulatory frameworks, and industry relationships;
expanding each query by incorporating related entities and semantic relationships from the domain-specific knowledge graph to generate enhanced sub-queries;
generating vector embeddings for the enhanced sub-queries using a trained embedding model; and
querying a vector database with the generated embeddings to retrieve candidate documents.

12. The system of claim 9, wherein filtering the information based on contextual relevance comprises:
applying noise filtering algorithms to eliminate documents that do not meet relevance thresholds;
dynamically re-ranking retrieved documents using a retrieval model that considers user objectives and query context; and
selecting a subset of highest-ranked documents to provide as context for the one or more generative language models.

13. The system of claim 9, wherein generating query-specific outputs comprises:
providing the filtered information as context within structured prompts to one or more large language models; and
receiving individual query responses from the large language models for each of the plurality of queries;
wherein different queries are routed to different specialized generative language models based on domain-specific expertise required for each query.

14. The system of claim 9, wherein synthesizing the query-specific outputs through iterative processing comprises:
combining the query-specific outputs into an intermediate comprehensive analysis;
submitting the intermediate analysis to the one or more generative language models with instructions to identify information gaps;
generating additional follow-up queries based on identified gaps;
processing the follow-up queries through the augmented retrieval system; and
repeating the iterative process until predetermined completeness criteria are satisfied.

15. The system of claim 9, wherein generating the structured report comprises:
formatting the comprehensive analysis according to a predetermined template associated with the selected task;
generating multiple report sections including an introduction, analysis content, and conclusions;
incorporating visual elements including charts and graphs generated by multi-modal artificial intelligence models; and
presenting the structured report through a user interface that allows for export in multiple document formats.

16. The system of claim 9, further comprising:
receiving one or more example documents from the user that represent a desired output format;
analyzing the example documents using the one or more generative language models to identify required report sections and content types;
generating supplemental queries based on the analysis of the example documents;
processing the supplemental queries through the augmented retrieval system to gather additional information; and
comparing the generated structured report with the example documents to ensure format and content alignment.

17. A computer-implemented method for generating task-based reports, the method comprising:
receiving, by a computing system, a selection of a predefined task from a user interface, wherein the predefined task corresponds to a specific type of report to be generated and is associated with a workflow comprising a plurality of queries;
receiving one or more input parameters associated with the selected task, wherein the one or more input parameters include at least one of a company name, date range, industry, or sector;
decomposing the selected task into the plurality of queries, wherein each query is configured to retrieve specific information relevant to completing the predefined task;
for each query of the plurality of queries:
augmenting the query using a domain-specific knowledge graph to generate one or more sub-queries,
generating embeddings for the augmented queries using an embedding model,
querying a vector database with the generated embeddings to retrieve a set of candidate documents,
filtering the candidate documents using a retrieval model and noise filtering algorithms to identify relevant documents,
dynamically re-ranking the relevant documents based on context and user objectives, and
providing the re-ranked documents as context to a generative language model to generate a query-specific output;
iteratively processing the query-specific outputs from the plurality of queries through the generative language model to synthesize the information into a comprehensive analysis;
formatting the synthesized information according to a predetermined report structure associated with the selected task to generate a final report comprising multiple sections relevant to the predefined task; and
resenting the final report to the user through the user interface, wherein the final report is customized based on the selected task and input parameters.

18. The computer-implemented method of claim 17, wherein the predefined tasks are presented to the user in a role-based manner, and wherein the method further comprises:
identifying a role of the user accessing the system;
filtering the available predefined tasks based on the identified role to present only tasks relevant to the role of the user; and
customizing the user interface to display role-specific tasks, wherein an investment analyst is presented with tasks related to market analysis and investment memoranda, and a compliance officer is presented with tasks related to regulatory compliance and risk assessment.

19. The computer-implemented method of claim 17, further comprising:
receiving one or more example documents from the user that represent a desired output format for the final report;
analyzing the example documents using the generative language model to identify report sections, information types, and formatting requirements;
generating additional queries based on the analysis of the example documents to supplement the plurality of queries associated with the predefined task; and
comparing the generated final report with the example documents to identify missing information and iteratively refining the report until it substantially matches a format and content scope of the example documents.

20. The computer-implemented method of claim 17, wherein augmenting the query using the domain-specific knowledge graph comprises:
accessing a knowledge graph containing domain-specific entities, relationships, and concepts relevant to financial analysis;
identifying entities within the original query that correspond to nodes in the knowledge graph; and
expanding the query by incorporating related entities and relationships from the knowledge graph to generate semantically enriched sub-queries;
wherein the domain-specific knowledge graph includes financial entities, company relationships, industry classifications, and regulatory frameworks.

21. The computer-implemented method of claim 17, wherein iteratively processing the query-specific outputs comprises:
combining the query-specific outputs into an intermediate comprehensive analysis;
submitting the intermediate analysis to the generative language model with instructions to identify gaps or missing information;
generating follow-up queries based on identified gaps to retrieve additional information;
processing the follow-up queries through the same augmentation, embedding, retrieval, and filtering steps; and
repeating the iterative process until the comprehensive analysis meets predetermined completeness criteria.

22. The computer-implemented method of claim 17, wherein the generative language model comprises a multi-modal large language model capable of processing both text and visual information, and wherein formatting the synthesized information further comprises:
generating visual elements including charts, graphs, and diagrams based on the synthesized information;
incorporating the visual elements into the predetermined report structure; and
applying formatting rules specific to the selected task to create a professionally formatted document suitable for a role of the user and organizational requirements.

23. The computer-implemented method of claim 17, wherein the system utilizes multiple specialized generative language models, and wherein the method further comprises:
routing different queries to different generative language models based on specific domain expertise required for each query;
wherein a first generative language model is optimized for financial data analysis, a second generative language model is optimized for legal document interpretation, and a third generative language model is optimized for market trend forecasting; and
aggregating outputs from the multiple specialized generative language models to create the comprehensive analysis.
